(19) United States
(12) Patent Application Publication
(10) Pub. No.: US 2014/0188612 A1
(43) Pub. Date: Jul. 3, 2014

(54) DIRECTED CONTENT PRESENTATION

(71) Applicant: Google Inc., (US)

(72) Inventors: Linus Chou, San Francisco, CA (US); Manzurur Rahman Khan, Mountain View, CA (US)

(73) Assignee: Google Inc., Mountain View, CA (US)

(21) Appl. No.: 13/731,826

(22) Filed: Dec. 31, 2012

(51) Int. Cl. G06Q 30/02

(52) U.S. Cl. CPC G06Q 30/0257
USPC 705/14.55

(57) ABSTRACT

Methods, systems, and apparatus, including computer programs encoded on computer storage media, for content presentation. One of the methods includes, receiving, from a user device, a request for sponsored content; identifying a sponsored content item responsive to the request; determining a device type associated with the user device; modifying one or more presentation parameters associated with the sponsored content item based at least in part on the device type associated with the user device; and providing the sponsored content item having the modified presentation parameters to the user device.

### BACKGROUND

This instant specification relates to content presentation.

Content providers can provide content including sponsored content such as advertisements. For example, advertisers provide advertisements in different forms in order to attract consumers. An advertisement, or “ad,” is a piece of information designed to be used in whole or part by a user, for example, a particular consumer. Typically, different display parameters can be specified for and used in different parts of ads. For example, different colors can be specified such as white letters on a background having a particular shade of blue. However, not all devices may display the same particular shade of blue in exactly the same way.

### SUMMARY

This specification describes technologies relating to content presentation.

Content can be shown on many different types of devices, ranging from many different types of mobile devices and non-mobile devices, including personal computers, laptop computers, and other devices capable of displaying content, e.g., set-top boxes, etc. Each device can have different display properties. For example, different displays may show colors differently based on hardware properties or both hardware and software properties. Specifically, the same sponsored content item provided by a content sponsor may appear differently on two mobile devices of different types, or a mobile device and some type of non-mobile device. Colors that are displayed can be important, as user behavior, e.g., click-through rates, conversions, etc., may change depending on how the appearance of sponsored content items.

In some implementations, different versions of a sponsored content item are provided, for example, where each version has a different color combination. For example, a shade of blue, used as a background color of the sponsored content item, can be varied slightly, e.g., within a specified range, to create different versions of the same sponsored content item with different backgrounds of blue. As the sponsored content items are provided over time to users, impressions, clicks and/or conversions can be logged. In some implementations, machine learning algorithms can be applied based on the logged information, e.g., to dynamically modify the different parameters and to optimize the performance of sponsored content items against particular performance metrics such as selections or conversions of the sponsored content items. As a result, while a publisher may initially specify the sponsored content item as having a particular color scheme, the color(s) may be changed automatically, e.g., based on analysis of user interactions with different versions of the sponsored content item. Then, for each unique device, the color scheme can further be varied slightly to optimize it for the display of that device, e.g., to correspond to a version of the ad that resulted in better user interactions or for other reasons.

In general, one innovative aspect of the subject matter described in this specification can be embodied in methods that include the actions of receiving, from a user device, a request for sponsored content; identifying a sponsored content item responsive to the request; determining a device type associated with the user device; modifying one or more presentation parameters associated with the sponsored content item based at least in part on the device type associated with the user device; and providing the sponsored content item having the modified presentation parameters to the user device. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The one or more presentation parameters include color parameters. The modifying is further based on a particular publisher. The modifying is further based on a particular color scheme of an application or website. The modifying is further based on a particular web site. Modifying the presentation parameters includes changing at least one presentation parameter based, at least in part, on display properties of the user device. Changing the at least one presentation parameter includes: determining the display properties of the user device; and changing the at least one presentation parameter to compensate for the determined display properties. Changing the at least one presentation parameter to compensate for the determined display properties includes changing the at least one presentation parameter such that the presentation by the user device corresponds to an intended presentation of the sponsored content item. Modifying presentation parameters includes accessing information that identifies, on a device type basis, preferred presentation parameters and presentation parameters to be avoided. The information is based on past user interactions with content items using the presentation parameters. The information includes transformation information for transforming a presentation parameter to be avoided to a preferred presentation parameter.

In general, one innovative aspect of the subject matter described in this specification can be embodied in methods that include the actions of creating a plurality of different versions of a sponsored content item, each version having a different set of presentation parameters; providing one of the different versions to each respective user of a plurality of users in response to respective requests for sponsored content items; logging, over time, user interactions associated with each of the different versions; selecting a particular version of the sponsored content item from the different versions based at least in part on the logged interactions; and providing the selected particular version in response to subsequent requests for content in which the sponsored content item is selected to be provided. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. User interactions include click-through rates and conversion rates. The presentation parameters include color parameters. Providing one of the different versions includes providing the different version based at least in part on a device type of a user device associated with the respective user. The different version is created, at least in part, by changing at least one presentation parameter based on display properties of the user device. The selecting the particular version of the sponsored content item from the different versions based at least in part on the logged interactions include determining that the particular version outperforms the other versions of the sponsored content item by a threshold amount

The systems and techniques described here may provide one or more of the following advantages. The system can provide sponsored content items having consistent display output across devices having different display types. The system can adjust colors for sponsored content items to optimize performance of the sponsored content items. The system can adjust colors for content items based on device, using knowledge of colors on for a variety of devices. The system can adjust color based on a specific application, where the color scheme surrounding the content item can affect its relevant properties, for example, click through rate.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a block diagram of an example content presentation system.

FIG. 2 shows an example computer system for providing sponsored content items with modified presentation parameters.

FIG. 3 shows the computer system for providing a particular version of a sponsored content item based on previous user interactions with different versions of the sponsored content item.

FIG. 4 shows a flow diagram of an example process for providing a sponsored content item with modified presentation parameters.

FIG. 5 shows a flow diagram of an example process for providing a particular version of a content item based on previous user interactions with different versions of the sponsored content item

FIG. 6 shows an example of a computing device and a mobile computing device that can be used in connection with computer-implemented methods and systems described in this document.

Like reference symbols in the various drawings indicate like elements.

### DETAILED DESCRIPTION

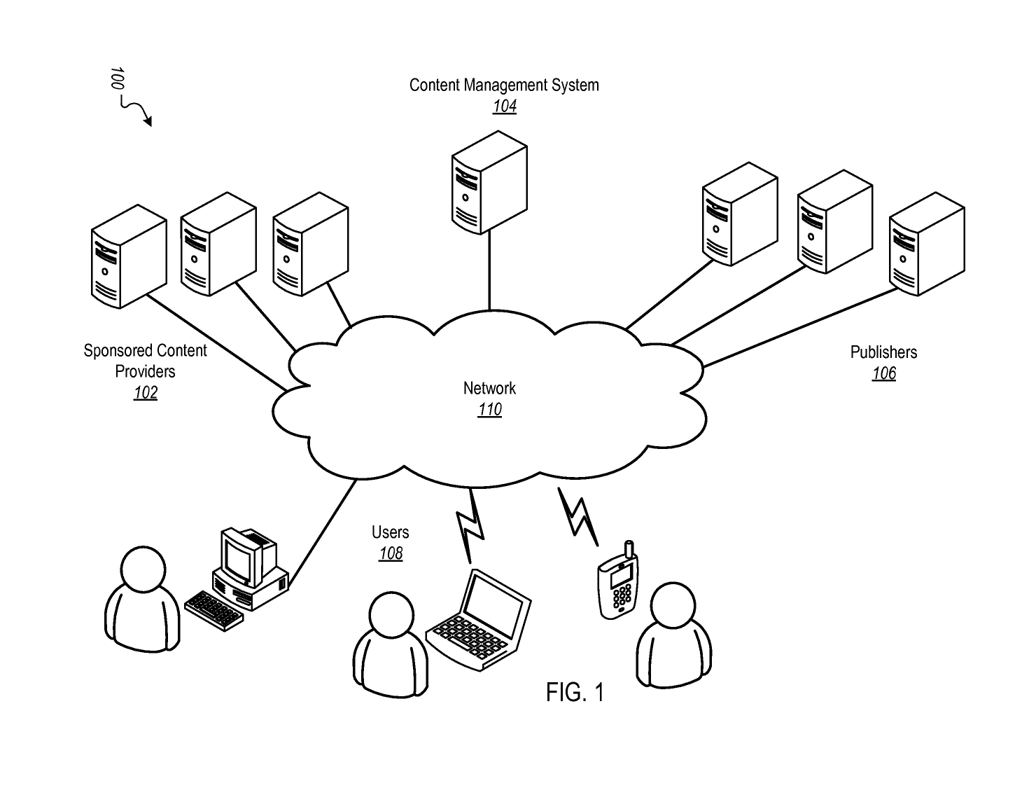

FIG. 1 is a block diagram of an example content presentation system 100. In some implementations, one or more sponsored content providers 102, e.g., advertisers, directly, or indirectly, enter, maintain, and log ad information in a content management system 104, e.g., an advertising management system. Though reference is made to advertising, other forms of content, including other forms of sponsored content, can be delivered by the system 100. The sponsored content can be in the form of graphical ads, for example, banner ads, text only ads, image ads, and barcode ads, e.g., ads that include one or more barcodes used, for example, in ad redemption, audio ads, video ads, animated ads, ads combining one or more of any of such components, etc. The sponsored content can also include embedded information, such as links, meta-information, and/or machine executable instructions. One or more publishers 106 may submit requests for sponsored content to the system 104. The system 104 responds by sending sponsored content to the requesting publisher 106 for placement on or association with one or more of the publisher's content items, e.g., web properties, mobile applications. Example web properties can include web pages, television and radio advertising slots, or print media space. Example mobile applications can include media players, games, messaging clients, and other applications configured to execute on phones, tablets, and other mobile computing devices.

Other entities, such as users 108 and the sponsored content providers 102, can provide usage information to the system 104, for example, whether or not a conversion, e.g., a purchase or other interaction, or a click-through related to sponsored content, e.g., a user has selected an ad, has occurred. This usage information can include measured or observed user behavior related to sponsored content items that have been served. The system 104 may perform financial transactions, for example, crediting the publishers 106 and charging the sponsored content providers 102 based on the usage information.

A network 110, such as a local area network (LAN), wide area network (WAN), the Internet, one or more telephony networks or a combination thereof, connects the sponsored content providers 102, the system 104, the publishers 106, and the users 108.

One example publisher 106 is a general content server that receives requests for content, e.g., articles, discussion threads, music, video, graphics, search results, web page listings, information feeds, etc., and retrieves the requested content in response to the request. The content server can submit a request for sponsored content to an advertisement server in the system 104. Alternatively, a request for sponsored content can be embedded in content from the publisher being rendered on a user device such that the user device, e.g., a browser, submits the request. The request can include a number of sponsored content items desired. The request can also include content request information. This information can include the content itself, e.g., page, video broadcast, radio show, or other type of content, a category corresponding to the content or the content request, e.g., arts, business, computers, arts-movies, arts-music, etc., part or all of the content request, content age, content type, e.g., text, graphics, video, audio, mixed media, etc., geo-location information, etc.

In some implementations, the content server or a client browser combines the requested content with one or more of the sponsored content items provided by the system 104. The combined content and sponsored content items can be sent/rendered to the users 108 that requested the content for presentation in a viewer, e.g., a browser or other content display system. The content server can transmit information about the sponsored content items back to the advertisement server, including information describing how, when, and/or where the sponsored content items are to be rendered, e.g., in HTML or based on scripting. In some implementations, the content and sponsored content items are combined separately. For example, content can be rendered while waiting for sponsored content items to be received and incorporated into the content.

Another example publisher 106 is a search service. A search service can receive queries for search results. In response, the search service can retrieve relevant search results from an index of documents, e.g., from an index of web pages. Search results can include, for example, lists of web page titles, snippets of text extracted from those web pages, and hypertext links to those web pages, and may be grouped into a predetermined number of, e.g., ten, search results.

The search service can submit a request for sponsored content, e.g., ads, to the system 104. The request may include a number of sponsored content items desired. This number can depend, for example, on the search results, the amount of screen or page space occupied by the search results, the size and shape of the sponsored content items, etc. The request for sponsored content may also include the query, as entered or parsed, information based on the query, such as geo-location information, whether the query came from an affiliate and an identifier of such an affiliate, and/or information associated with, or based on, the search results. Such information can include, for example, identifiers related to the search results, e.g., document identifiers or “docIDs”, scores related to the search results, e.g., information retrieval (“IR”) scores, snippets of text extracted from identified documents, e.g., web pages, full text of identified documents, feature vectors of identified documents, etc. In some implementations, IR scores are computed from, for example, dot products of feature vectors corresponding to a query and a document, page rank scores, and/or combinations of IR scores and page rank scores, etc.

Another example publisher 106 is an application publisher. An application publisher can develop applications for a variety of uses on one or more computing platforms. A mobile application is an application specifically designed for operation on a mobile device, e.g., a smart phone. For mobile platforms, network efficiency and computational efficiency may be of importance, based on the resources available to applications executing on mobile platforms.

The mobile applications developed by the application publisher can submit a request for sponsored content to the system 104, e.g., for ads to display while a user is interacting with or viewing the application. The application may periodically request additional sponsored content from the system 104, either as a single sponsored content item or a batch of sponsored content items. Each sponsored content item can be displayed for a period of time determined by a refresh rate determined for the application, after which time the sponsored content item can be replaced by a new sponsored content item.

In some implementations, the content management system 104 can use an auction process to select sponsored content items from the sponsored content providers 102. For example, the sponsored content providers 102 may be permitted to select, or bid, an amount the advertisers are willing to pay for each presentation of or interaction with, e.g., click, a sponsored content item, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, sponsored content items can be selected and ranked for presentation.

The search service can combine the search results with one or more of the sponsored content items provided by the system 104. This combined information can then be forwarded to the users 108 that requested the content. The search results can be maintained as distinct from the sponsored content items, so as not to confuse the user between, e.g., paid ads and presumably neutral search results.

In some implementations, one or more publishers 106 submit requests for sponsored content to the content management system 104. The system 104 responds by sending sponsored content items to the requesting publisher 106 for placement on one or more of the publisher's web properties, e.g., websites and other network-distributed content that are relevant to the web property. For example, if a publisher 106 publishes a sports-related web site, the advertising management system can provide sports-related sponsored content items to the publisher 106. In some implementations, the requests can instead be executed by devices associated with the user 108, e.g., by the execution of a particular script when the publisher's web page is loading on a client device. For example, content being loaded by a user's browser can include scripts indicating a request for sponsored content is to be made to the content management system 104. The sponsored content items are requested and can be integrated into the publisher content separately as received or display of the content can be halted until the requested sponsored content items are received.

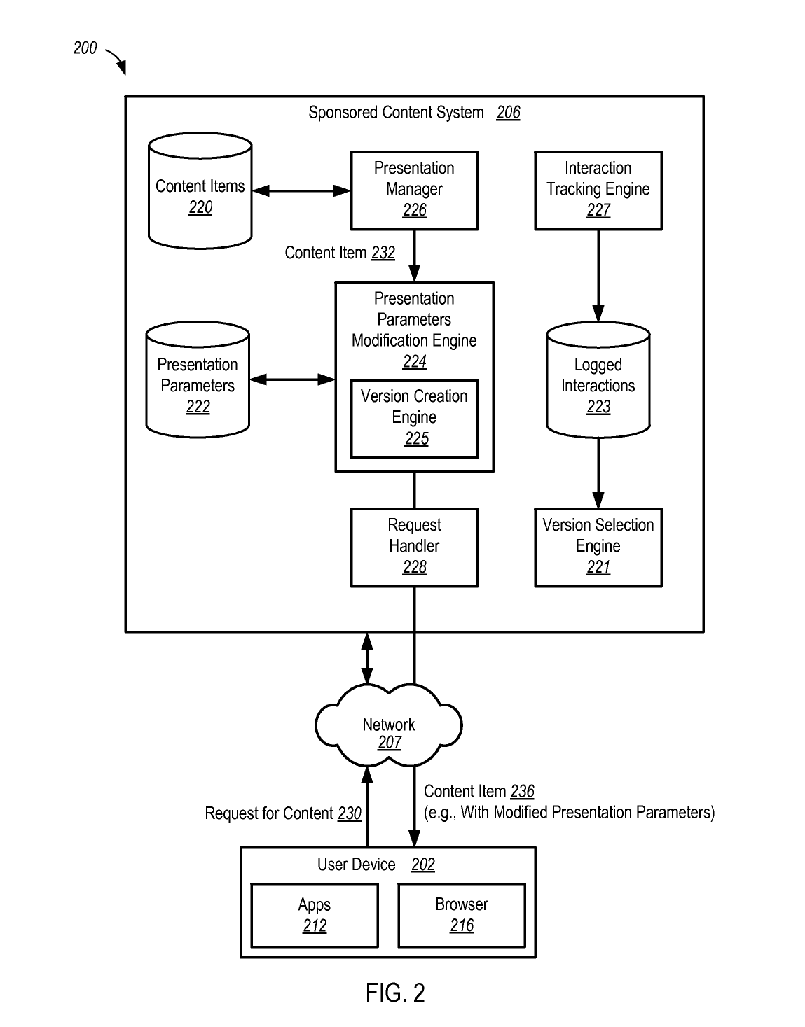

FIG. 2 shows an example computer system 200 for providing sponsored content items with modified presentation parameters. For example, the computer system 200 can be used to provide content items to the user device 202, where the content items may include modified presentation parameters for display of the content items on the user device 202. Communication between user device 202 and sponsored content system 206 can occur using a network 207.

User device 202 is a general or specific use computer device that is capable of displaying content on using various graphical user interfaces, for example, an application user interface, a browser user interface, and so on. In addition to the displayed content, sponsored content items, e.g., advertisements, can be presented. Examples of such user devices include, but are not limited to, mobile devices, e.g., smartphones and tablets, desktop computing devices, e.g. desktop, laptop, or server systems, and specialty computer devices, e.g. in-dash navigation and entertainment systems in an automobile, television media centers, televisions and set-top boxes. User device 202 is also capable of communicating across the data network 207, which may include, but is not limited to, wide area networks (WANs), local area networks (LANs), the Internet, and cellular networks.

User device 202 can execute various applications 212. Some or all of the applications 212, may have been downloaded and installed from one or more application markets or from other sources. For example, some applications 212 may be pre-loaded by a device manufacturer or downloaded directly from an application publisher website, etc. User device 202 includes a browser 216, e.g., which may be an application like the applications 212 or part of the operating system of the user device 202.

The applications 212 and the browser 216 can present content to a user. For example, applications 212 and the browser 216 can present a graphical user interface to users to provide that user with a particular functionality. Example applications 212 can include, but are not limited to, news aggregators, games, productivity application, social networking applications, content browsers, and utility applications. The browser 216 can be a web browser or other content browser that shows documents to a user. One or more of the applications 212 and the browser 216 can display sponsored content to a user. In some cases, the sponsored content is shown directly by the applications 212 or the browser 216. In other cases, the sponsored content is included along with other content or data being displayed. e.g., a web page content, game application content, etc.

The sponsored content system 206 can include a presentation manager 226. The presentation manager 226 can receive sponsored content requests from user device 202 and determine which content 220, e.g., one or more sponsored content items, to serve in response. The sponsored content requests may originate from, for example, the applications 212 or in response to rendering documents, e.g., web pages, from a publisher on the browser 216. Alternatively, the sponsored content requests can be received from publishers requesting sponsored content items to be provided to a client and incorporated into publisher content being displayed on the browsers.

The presentation manager 226 can select, from among candidate items, sponsored content 220 to be returned based on, e.g., the requesting user device 202, the user of the requesting device 202, content being requested for presentation, and/or information in the request. For example, the presentation manager 226 can match content 220 to sponsored content requests based on keywords in the ad request, e.g., identifying content item 232 in response to request for content 230. A specific example is an advertisement for running shoes that is identified in response to a request for content to fill an ad slot having selection parameters associated with running shoes. The identified advertisement can be a text only ad, an image ad, a combination of image and text, etc.

A presentation parameters modification engine 224 can modify presentation parameters for a sponsored content item, e.g., sponsored content item 232. The sponsored content item 232 can be, for example, an ad for running shoes. For example, the modification, e.g., a modification of color parameters, can be based at least in part on a determined device type associated with the request for content 230. This can be, for example, to account for certain colors do not display as intended on a particular device, such as not exactly corresponding with the specifications of the selected color, or for other reasons.

As an example, the modification can be to change a blue background color of an advertisement to a slightly different shade of blue based on how user device 202 renders certain colors on a display, for example, of applications 212 and/or browser 216.

Specifically, the running shoes pictured in the advertisement may be superimposed on a blue background. In some implementations, a data store of presentation parameters 222 can contain, on a per-device type basis, information for modifying presentation parameters. As an example, for the device type associated with user device 202, the presentation parameters 222 can include instructions to change blue color #4169E1 o blue color #4876FF. The presentation parameters 222 may include the same or different instructions for changing the same or other different colors for other different device types. In some cases, e.g., when colors in an advertisement need not be changed for presentation on a device of a certain device type, the content item 232 can remain unchanged and used as is for the content item 236 provided to the user device 202.

In some implementations, the modified presentation parameters are selected to compensate for errors in displaying the sponsored content item on a particular display of the user device 202. For example, changing blue color #4169E1, as originally specified by the sponsored content item, to #4876FF may result in a displayed color by the display of the user device that perceptively matches the original specified color #4169E1.

In some implementations, the presentation parameters 222 include information about the display properties of different types of devices. Changing at least one presentation parameter of a sponsored content item can include determining the display properties of the user device, e.g., based on device type information included with the request for content, and using the device type to look up display properties of the device in the presentation parameters 222. The presentation parameters modification engine 224 can modify presentation parameters for the sponsored content item, changing at least one presentation parameter to compensate for the determined display properties of the device, e.g., to present an intended presentation of the color for the sponsored content item.

In some implementations, modification of presentation parameters can occur for other reasons instead of, or in addition to, color or other presentation parameters that are modified due to display properties of the user device. For example, a particular publisher may have specific presentation parameters that are to be used and/or avoided. In this example, the presentation parameters 222 can include information that indicates that certain parameters are to be changed when a sponsored content item associated with a particular publisher is selected in response to a request for content.

In another example, an application or a website may have a particular color scheme. The presentation parameters 222 can indicate, for example, that when a content item is selected that is to be provided within application X or in a particular website W, color C is to be changed to C′ so as not to conflict with application X's or website W's color scheme.

In some implementations, the presentation parameters 222 include information that indicates, on a per device type basis, preferred presentation parameters and presentation parameters to be avoided. For example, preferred presentation parameters associated with device type A may indicate that blue color #4876FF is a preferred shade of blue. In another example, preferred presentation parameters associated with device type B may indicate that blue color #4169E1 is a shade of blue that is to be avoided.

In some implementations, information about presentation parameters that are preferred or to be avoided can be based, for example, on past user interactions with sponsored content items using the presentation parameters, such as higher or lower than average click-through rates and conversions associated with versions of sponsored content items using those presentation parameters. In some implementations, for presentation parameters that are to be avoided, the presentation parameters 222 can include transformation information for changing a presentation parameter from one value to another.

Some implementations include a version creation engine 225, which can be part of the presentation parameters modification engine 224 or a separate entity. The version creation engine 225 can create one or more versions of a sponsored content item, e.g., sponsored content item 232, using modified presentation parameters. For example, in response to the request for content 230, the version creation engine 225 can create a single modified version of sponsored content item 232, e.g., to change blue color #4169E1 to blue color #4876FF for the background in the running shoes ad.

In some implementations, the version creation engine 225 may be used to generate multiple different versions of the sponsored content item 232, each with different modifications to the presentation parameters. For example, it may be worthwhile to determine which color combinations work best for a particular device type, or to determine which color combinations work best for a particular sponsored content item, e.g., independent of the device type. To make these determinations, e.g., for a particular ad with a background using blue color #4169E1, the version creation engine 225 may create versions of the ad where blue color #4169E1 is replaced by blue color #4876FF, blue color #436EEE, blue color #3A5FCD, or blue color #6495ED.

A request handler 228 can provide an interface within the sponsored content system 206 for receiving requests for content and providing sponsored content items responsive to the requests. For example, request handler 228 can receive the request for content 230 from user device 202 and provide sponsored content item 236 in response to the request. In examples in which the presentation parameters modification engine 224 has not modified presentation parameters, e.g., when color backgrounds are suitable as-is, the sponsored content item 236 can be the same as the sponsored content item 232. In examples in which the presentation parameters modification engine 224 has modified presentation parameters, e.g., to change a background of blue color #4169E1 to blue color #4876FF, the sponsored content item 236 can be a variation of the sponsored content item 232.

Color parameters are just one example of presentation parameters that can be changed or varied. Other presentation parameters can include fonts or other styles, or any other aspects of a sponsored content item that may affect a user's reaction to the sponsored content item.

Over time, a transaction tracking engine 227 can log user interactions associated with each of the different versions of a sponsored content item provided to respective users. For example, the user interactions that are logged with regard to the running shoes ad can include click-through rates and conversion rates that occurred for each of the different versions of the ad, e.g., having different blue backgrounds. In some implementations, information about the different versions of a sponsored content item and user interactions associated with each of the different versions can be stored in a data store of logged interactions 223.

A version selection engine 221 can select a particular version from the different versions based at least in part on the logged interactions. For example, logged interactions 223 may indicate that the highest number of click-through rates and conversions for the running shoes ad presented on user device 202 occur when the background color is blue color #4876FF. At some point in time, when that particular version of the sponsored content item e.g., the running shoe ad with a particular background color, is determined to have the highest number of click-through rates and conversions, the version selection engine 221 can select that version whenever the same sponsored content item is to be presented to a user device having the same device type. In some implementations, that particular version of the ad can be stored, e.g., in the sponsored content items 220 or in a different place. The stored version of the ad can then be used for subsequent responses to requests for ad.

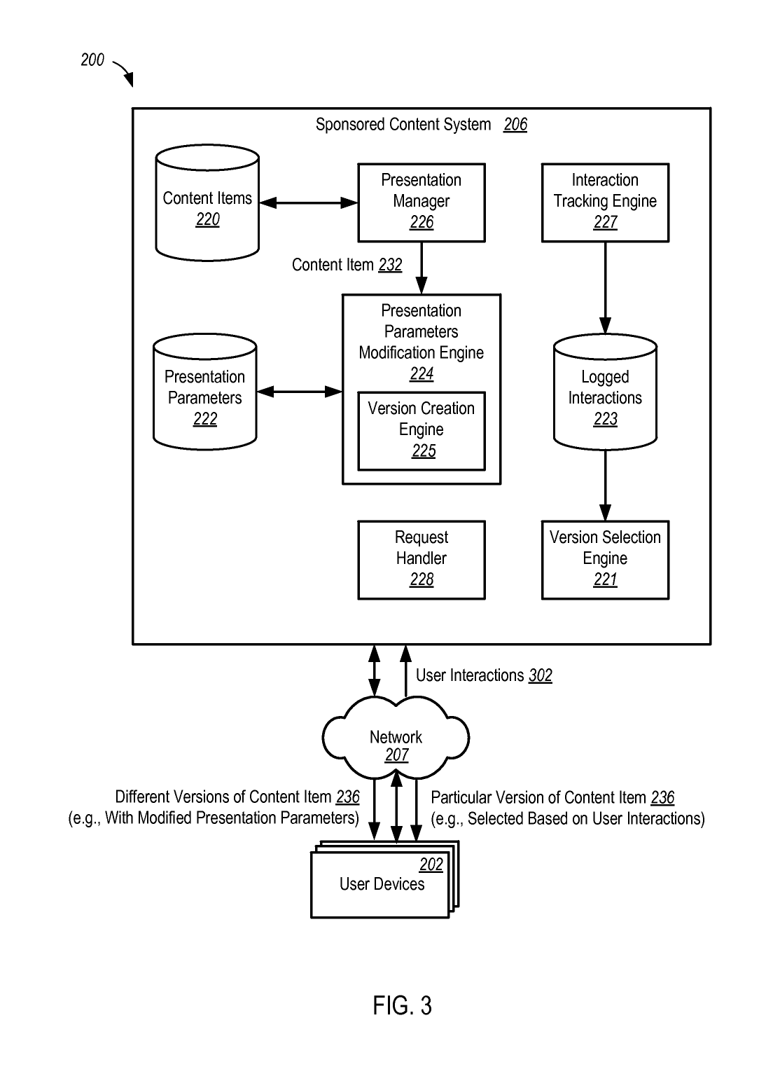

FIG. 3 shows the computer system 200 in which a particular version of a sponsored content item is provided based on previous user interactions with different versions of the sponsored content item. For example, over time, the sponsored content system 206 can provide different versions of the sponsored content item 236 to different user devices 202, e.g., of the same device type. The different versions can be created, for example, by the version creation engine 225 by modifying presentation parameters associated with the sponsored content item. As a result, each of the different versions of the sponsored content item has a different set of presentation parameters. Each one of the different versions is provided to a particular user device 202 of the user devices 202 in response to respective requests for content, for example, as described above.

Over time, user interactions 302 associated with each of the different versions are logged, and the information can be stored in the logged interactions 223. Eventually, it may be determined that one or more of the different versions out-performs the other versions, e.g., based on click-through rates, conversions or other user actions. In response, the version selection engine 221 can select a particular version of the sponsored content item 236, or more than one particular version, if several versions are performing substantially equally. The selection can be based, for example, on the logged interactions 223, and that version can be stored. Then, subsequent responses to requests for content can include providing the selected particular version of the sponsored content item.

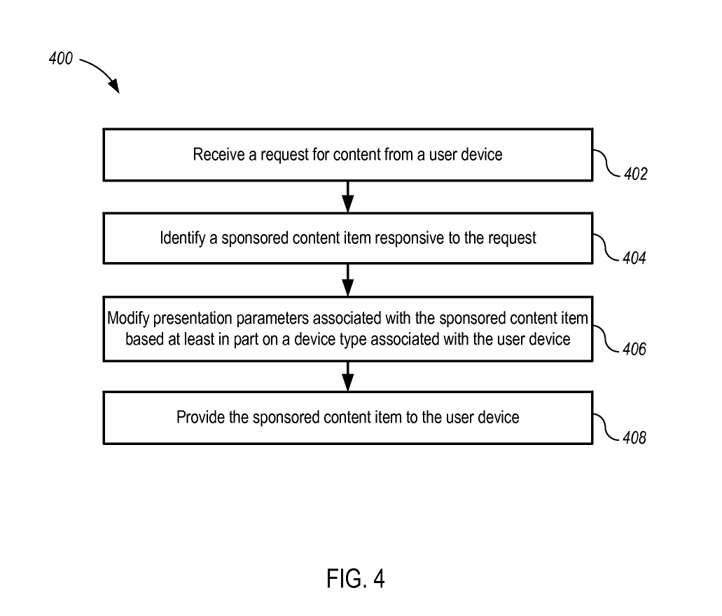

FIG. 4 shows a flow diagram of an example process 400 for providing a sponsored content item with modified presentation parameters. In some implementations, the process 400 may be performed by, for example, the sponsored content system 206, as described with reference to FIG. 2. As such, the example process 400 will be described in terms of the system that performs the process 400. However, another system or groups of systems may also perform the process 400.

The system receives a request for content from a user device 402. For example, the sponsored content system 206 can receive the request for content 230 from the user device 202.

The system identifies a sponsored content item responsive to the request 404. For example, a presentation manager, e.g., presentation manager 226, can identify a sponsored content item such as sponsored content item 232. The sponsored content item can be, e.g., an ad for running shoes. The presentation manager can identify the sponsored content item from content, e.g., based on keywords in the request for content or in other ways, e.g., a reservation system.

The system modifies presentation parameters associated with the content item based at least in part on a device type associated with the user device 406. For example, based on the device type of the user device, a presentation parameters modification engine, e.g., presentation parameters modification engine 224, can modify presentation parameters for the content item. The presentation parameters can be modified e.g., based on display properties of the user device. The presentation parameters modified, for example, can include color parameters, e.g., a background color in the ad for running shoes. In some implementations, in addition to modifying presentation parameters can further be based on a particular publisher, a particular color scheme of an application/website, and/or a particular web site, as described above.

The system provides the sponsored content item to the user device 408. For example, in response to the request for content, a request handler can provide the content item to the user device.

Although a particular number, order, and type of operations are described here, different numbers, orders, and types of operations are possible. For example, other signals can be used for determining how presentation parameters are to be modified, such as an amount of light currently available at the user device that sends the request for content.

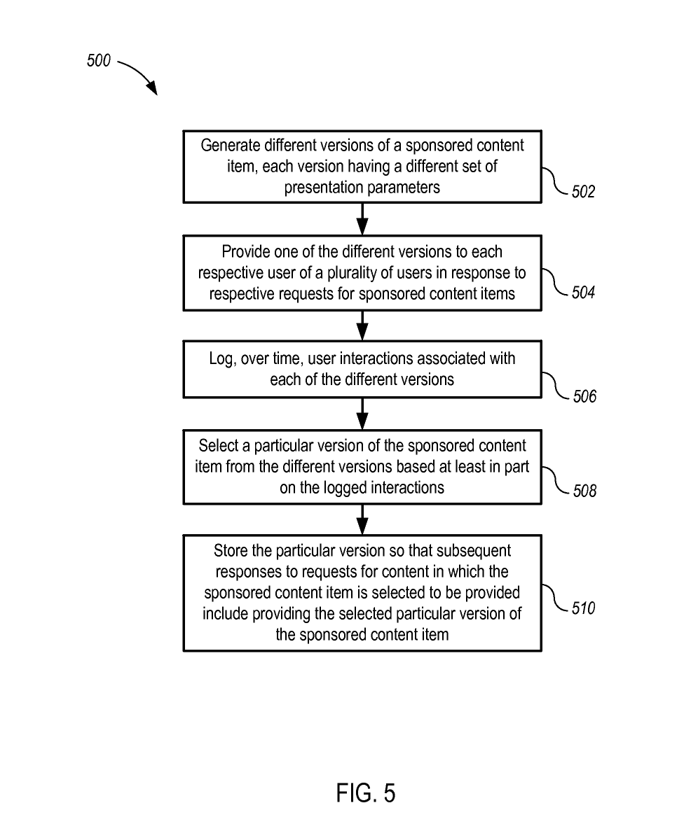

FIG. 5 shows a flow diagram of an example process 500 for providing a particular version of a sponsored content item based on previous user interactions with different versions of the sponsored content item. In some implementations, the process 500 may be performed by, for example, a request handler within a computer system, e.g., computer system 200, as described with reference to FIG. 3. As such, the example process 500 will be described in terms of a system that performs the process 500. However, another system or groups of systems may also perform the process 500.

The system generates different versions of a sponsored content item, each version having a different set of presentation parameters 502. For example, a version creation engine, e.g., version creation engine 225 of FIG. 3, can create one or more versions of a content item using modified presentation parameters.

The system provides one of the different versions to each respective user of a plurality of users in response to respective requests for sponsored content in which the sponsored content item is selected 504. For example, over time, a sponsored content system can provide different versions of the sponsored content item to user devices. The different version can be created, for example, by a version creation engine, e.g., the version creation engine 225, by modifying presentation parameters associated with the sponsored content item. As a result, each of the different versions of the sponsored content item that is generated has a different set of presentation parameters.

The system logs user interactions associated with each of the different versions over time 506. For example, a transaction logging engine, e.g., the transaction logging engine 227, can log user interactions associated with each of the different versions of the content item. For example, the user interactions that are logged with regard to a running shoes ad can include click-through rates and conversion rates that occurred for each of the different versions of the ad, e.g., versions having different blue backgrounds. In some implementations, information about the different versions of a sponsored content item and user interactions associated with each of the different versions of the sponsored content item can be stored in a data store of logged interactions.

The system selects a particular version of the sponsored content item from the different versions based at least in part on the logged interactions 508. Eventually, it may be determined that one or more of the different versions out-performs the other versions, e.g., based on click-through rates, conversions or other user actions. As such, a version selection engine, e.g., the version selection engine 221, can select a particular version of the sponsored content item, or more than one particular version, if several versions may be performing substantially equally. The selection can be based, for example, on the logged interactions.

The system stores the particular version of the sponsored content item so that subsequent responses to requests for content, in which the sponsored content item is selected, include providing the selected particular version of the sponsored content item 510.

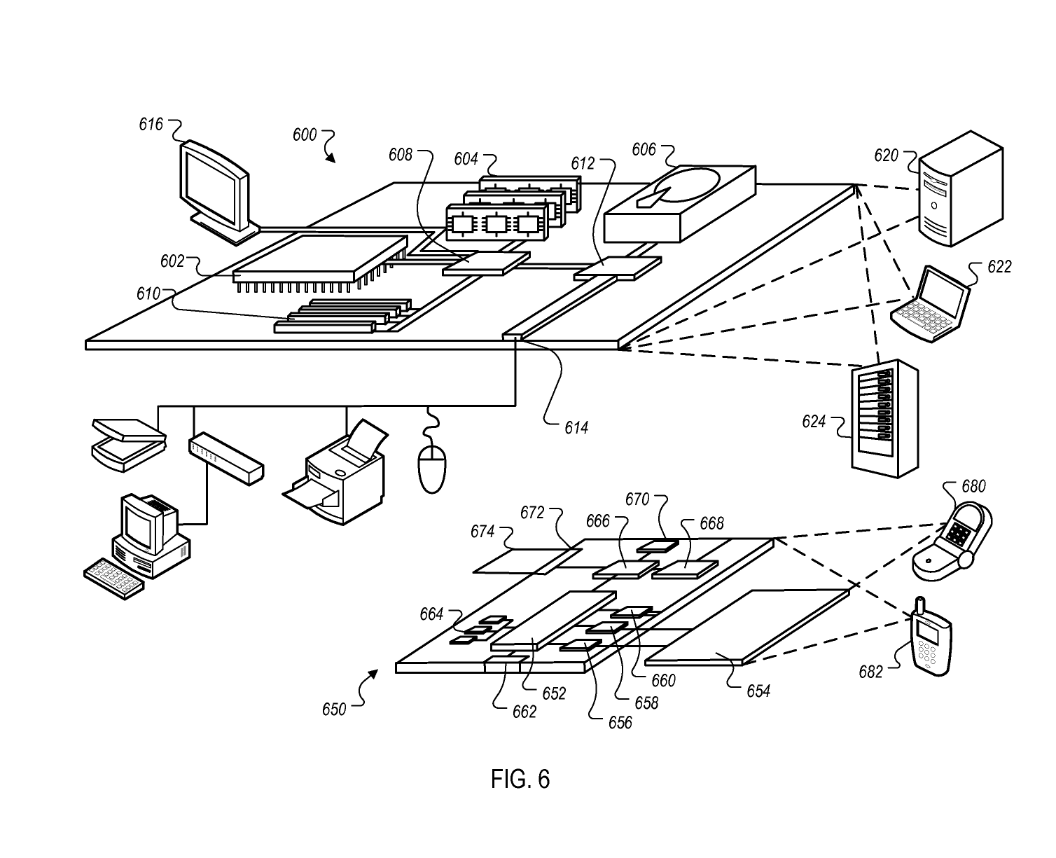

FIG. 6 shows an example of a computing device 600 and a mobile computing device that can be used to implement the techniques described here. The computing device 600 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations, e.g., as a server bank, a group of blade servers, or a multi-processor system.

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is exemplary only. In some implementations, the high-speed interface 608 is coupled to the memory 604, the display 616, e.g., through a graphics processor or accelerator, and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 664, the expansion memory 674, or memory on the processor 652. In some implementations, the computer program product can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound, e.g., voice messages, music files, etc., and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method comprising:
receiving, from a user device, a request for sponsored content;
identifying a sponsored content item responsive to the request;
determining a device type associated with the user device;
modifying one or more presentation parameters associated with the sponsored content item based at least in part on the device type associated with the user device; and
providing the sponsored content item having the modified presentation parameters to the user device.

2. The method of claim 1, wherein the one or more presentation parameters include color parameters.

3. The method of claim 1, wherein the modifying is further based on a particular publisher.

4. The method of claim 1, wherein the modifying is further based on a particular color scheme of an application or website.

5. The method of claim 1, wherein the modifying is further based on a particular web site.

6. The method of claim 1, wherein modifying the presentation parameters includes changing at least one presentation parameter based, at least in part, on display properties of the user device.

7. The method of claim 6, wherein changing the at least one presentation parameter includes:
determining the display properties of the user device; and
changing the at least one presentation parameter to compensate for the determined display properties.

8. The method of claim 7, wherein changing the at least one presentation parameter to compensate for the determined display properties includes changing the at least one presentation parameter such that the presentation by the user device corresponds to an intended presentation of the sponsored content item.

9. The method of claim 1, wherein modifying presentation parameters includes accessing information that identifies, on a device type basis, preferred presentation parameters and presentation parameters to be avoided.

10. The method of claim 9, wherein the information is based on past user interactions with content items using the presentation parameters.

11. The method of claim 10, wherein the information includes transformation information for transforming a presentation parameter to be avoided to a preferred presentation parameter.

12. The method of claim 1, wherein the modifying is based on a color scheme of an application in which the content item is to be presented.

13. A method comprising:
creating a plurality of different versions of a sponsored content item, each version having a different set of presentation parameters;
providing one of the different versions to each respective user of a plurality of users in response to respective requests for sponsored content items;
logging, over time, user interactions associated with each of the different versions;
selecting a particular version of the sponsored content item from the different versions based at least in part on the logged interactions; and
providing the selected particular version in response to subsequent requests for content in which the sponsored content item is selected to be provided.

14. The method of claim 13, wherein user interactions include click-through rates and conversion rates.

15. The method of claim 13, wherein the presentation parameters include color parameters.

16. The method of claim 13, wherein providing one of the different versions includes providing the different version based at least in part on a device type of a user device associated with the respective user.

17. The method of claim 16, wherein the different version is created, at least in part, by changing at least one presentation parameter based on display properties of the user device.

18. The method of claim 13, wherein the selecting the particular version of the sponsored content item from the different versions based at least in part on the logged interactions include determining that the particular version outperforms the other versions of the sponsored content item by a threshold amount.

19. A system comprising:
one or more computers configured to perform operations comprising:
receiving, from a user device, a request for sponsored content;
identifying a sponsored content item responsive to the request;
determining a device type associated with the user device;
modifying one or more presentation parameters associated with the sponsored content item based at least in part on the device type associated with the user device; and
providing the sponsored content item having the modified presentation parameters to the user device.

20. A system comprising:
one or more computers configured to perform operations comprising:
creating a plurality of different versions of a sponsored content item, each version having a different set of presentation parameters;
providing one of the different versions to each respective user of a plurality of users in response to respective requests for sponsored content items;
logging, over time, user interactions associated with each of the different versions;
selecting a particular version of the sponsored content item from the different versions based at least in part on the logged interactions; and
providing the selected particular version in response to subsequent requests for content in which the sponsored content item is selected to be provided.
